(19) United States
(12) Patent Application Publication
(10) Pub. No.: US 2024/0198995 A1
(43) Pub. Date: Jun. 20, 2024

(54) METHOD FOR OPERATING A HYDRAULIC BRAKE SYSTEM WITH ANALOG DETECTION OF BRAKE FLUID FILL LEVEL

(71) Applicant: ZF Active Safety GmbH, Koblenz (DE)

(72) Inventor: Andreas Marx, Hartenfels (DE)

(21) Appl. No.: 18/531,093

(22) Filed: Dec. 6, 2023

(30) Foreign Application Priority Data
Dec. 16, 2022 (DE) 102022213764.7

(51) Int. Cl. B60T 17/22; B60T 13/14

(52) U.S. Cl. CPC B60T 17/221; B60T 13/148; B60T 17/225

(57) ABSTRACT

A method for operating a hydraulic brake system for a motor vehicle that includes a hydraulic brake system with a hydraulic unit, a brake fluid reservoir and hydraulically actuatable wheel brakes, wherein the hydraulic unit has a main pressure source which can be actuated via a brake pedal, an additional pressure source fluidically separate from the main pressure source, and control valves by which the main pressure source and the additional pressure source on one side and the wheel brakes on the other side are connected together, wherein in the brake fluid reservoir, multiple at least partially mutually separate reservoir chambers are provided for supplying the main pressure source and the additional pressure source with a brake fluid, wherein the method comprises detection of a fill level of the brake fluid in the brake fluid reservoir by a measurement assembly, wherein the detection of the fill level takes place in analog fashion.

### CROSS-REFERENCE TO RELATED APPLICATION

This application claims priority to German Priority Application No. 102022213764.7, filed Dec. 16, 2022, the disclosure of which is incorporated herein by reference in its entirety.

### TECHNICAL FIELD

The disclosure concerns a method for operating a hydraulic brake system for a motor vehicle, a hydraulic brake system for a motor vehicle, a control device for operating a hydraulic brake system, and a motor vehicle comprising the control device.

### BACKGROUND

In conventional hydraulic brake systems, the fill level in the brake fluid reservoir can be determined using various principles. A detected fluid loss leads to a message in the vehicle display and, above a predetermined severity, to an illumination of a brake warning light.

Usually, it is left to the driver to react appropriately to the illuminated brake warning light. A brake warning light may be illuminated when the fill level reaches or falls below e.g. a critical value. Suitable sensors here comprise Reed switches for example. Depending on the warning severity, it is then permitted to drive the vehicle on to the nearest repair facility. In other cases, an immediate stoppage of the vehicle is imperative.

The message to the driver is not detailed. Also, often the system offers no counter-measures against a progressive fluid loss and the resulting loss of brake force.

In further hydraulic brake systems, a leak or contamination of the amplification system with air is detected, in order to derive suitable shut-down measures from this. For example, a complete shut-down of the electrical system may take place in order to fall back on actuation of the brakes purely by driver force.

Integrated hydraulic brake systems are also known which provide an active amplification of the brake pressure. The reservoir is here divided into several part regions. There have been various attempts to provide the part region used for amplification with a reliable device for determining the fill level.

For example, EP 3 724 045 B1 discloses a method for operating a brake system. A brake fluid reservoir is divided into two regions, wherein a fill level sensor is arranged in both regions. In response to a drop in fill level in one or both reservoirs below a specific value, the brake system is operated in an alternative mode. In this alternative mode, for example, the pressure may be supplied to the wheel brakes via the master brake cylinder or individual wheel brakes may be hydraulically isolated.

It is disadvantageous that no dedicated warning messages are given to the driver. The driver can only rely on the display of one or more warning lights, and from this conclude the relative severity of the warning message. A further disadvantage is that automatically triggered measures usually constitute major interventions in the function capacity of the vehicle, which irritate the driver and can reduce driving safety. For example, the maximal utilization of friction coefficient on braking of the motor vehicle may be reduced if, in a fallback level or depending on the severity of the leak, one or more wheel brakes are isolated from the hydraulic unit, wherein an aggravation of the fluid loss is prevented by the isolation. Furthermore, the maximal rate of reduction in brake force may be slowed when the brake system is in a test cycle for the function capacity of the analog measurement device. The isolation of individual wheel brakes can tend to destabilize the vehicle.

### SUMMARY

In this context, what is needed is a method for operating a hydraulic brake system, a corresponding control device for performing such a method, and a correspondingly configured hydraulic brake system, which at least partially eliminate the above-mentioned disadvantages.

Accordingly, the disclosure is directed to by a method for operating a hydraulic brake system for a motor vehicle, a hydraulic brake system for a motor vehicle, a control device for operating a hydraulic brake system, and a motor vehicle comprising the control device. Advantageous exemplary arrangements and refinements of the disclosure arise from the dependent claims.

The disclosure concerns a method for operating a hydraulic brake system for a motor vehicle, wherein the hydraulic brake system has a hydraulic unit, a brake fluid reservoir and hydraulically actuatable wheel brakes, wherein the hydraulic unit has a main pressure source which can be actuated via a brake pedal, an additional pressure source fluidically separate from the main pressure source, and control valves by which the main pressure source and the additional pressure source on one side and the wheel brakes on the other side are connected together, wherein in the brake fluid reservoir, multiple at least partially mutually separate reservoir chambers are provided for supplying the main pressure source and the additional pressure source with a brake fluid, wherein the method comprises detection of a fill level of the brake fluid in the brake fluid reservoir by a measurement assembly, wherein the detection of the fill level takes place in analog fashion.

The disclosure furthermore concerns a hydraulic brake system for a motor vehicle, comprising a hydraulic unit, a brake fluid reservoir and hydraulically actuatable wheel brakes. The hydraulic unit has a main pressure source which can be actuated via a brake pedal, an additional pressure source fluidically separate from the main pressure source, and control valves by which the main pressure source and the additional pressure source on one side and the wheel brakes on the other side are connected together. In the brake fluid reservoir, also multiple, at least partially mutually separate reservoir chambers are provided for supplying the main pressure source and the additional pressure source with a brake fluid. The hydraulic brake system furthermore comprises a measurement assembly for analog detection of a fill level of the brake fluid in the brake fluid reservoir.

The disclosure also concerns a control device for operating a hydraulic brake system, wherein the control device is adapted to perform the method, and a motor vehicle comprising the control device.

In the context of the present disclosure, the fill level in the brake fluid reservoir of the hydraulic system is detected by a measurement assembly in analog fashion. Analog detection here comprises assessment of the value to be measured, the fill level, using an analog measurement principle, i.e. in a stepless or continuous fashion. In other words, analog detection comprises continuous measurement. A continuous measurement may comprise regular detection of measurement values at small intervals, for example every five seconds or less, e.g. every second, or in real-time. In one exemplary arrangement, the frequency of recording measurement values may be adapted e.g. in response to a reduction in fill level. Thus with a constant fill level, measurement may take place every five seconds. As soon as a reduction in fill level is measured, depending on the reduction rate, the measurement values are recorded with greater frequency, e.g. every four seconds.

In this way, tendencies and fluctuations, for example, a reduction in the fill level can be measured at any arbitrary time, whereby a direct and rapid response to deteriorating measurement values is possible. In other words, this allows a selective process during protection and in some cases during degradation of the hydraulic brake system. Thus, a reduction in fill level can indicate a leak in the hydraulic brake system even at an early stage, for example, before specifically marked fill levels, e.g. a minimally permitted fill level, are reached or passed. Evaluation of the analog detection by a control device for example allows implementation of selectively graduated fallback reactions or a selectively graduated degradation of the brake system depending on an absolute brake fluid loss and/or its fall rate. This arrangement includes differentiated messages for the driver and in vehicle diagnosis, which may be provided on the basis of a fall rate level. Then further measures may be taken for detecting the leak, avoiding the leak or at least containing the fluid loss. A low fall rate may lead only to a corresponding entry in the diagnostic memory of the motor vehicle. A higher fall rate may contain a warning message to the driver requesting a visit to a workshop in the medium-term and/or trigger the performance of an automatic leak test. A high fall rate may lead to a warning message to the driver requesting a visit to a workshop as soon as possible and/or the performance of leak detection with the aim of isolating a damaged component of the brake system in targeted fashion where possible. Detection and evaluation of a fill level or fluid level drop and a brake function degradation which is graduated depending on the fall rate become possible. For example, in the case of a very rapidly dropping fill level, the motor vehicle must be brought to a standstill immediately, whereas on a slow fall, the remaining driving time or driving distance may be greater. The remaining driving time or driving distance can be calculated and displayed on the basis of or in proportion to the fall rate.

Using a fill level signal secured for example to ASIL (Automotive Safety Integrity Level) D, and in one exemplary arrangement, to ISO 26262, it may be permitted, on a falling fill level, to take certain protection measures and/or extend the system test during operation of the motor vehicle. A progressive fluid loss may be prevented in good time and suitable fallback measures taken to guarantee a remaining deceleration capacity of the vehicle. An insidious evacuation may not only be detected at an early stage but also effectively countered. With knowledge of the loss rate, graduated warnings may be provided for the driver and continued travel limited to a safe period. Also, often sufficient time remains for more extensive diagnosis of the hydraulic system so that a further loss can either be limited or completely suppressed.

According to one exemplary arrangement, the fill level is detected by the measurement assembly in analog fashion firstly in a common region in the brake fluid reservoir above the reservoir chambers separated by an intermediate wall or several intermediate walls, and after detection of a fill level fall, in only one of the reservoir chambers, which further is assigned to the additional pressure source. The brake fluid reservoir is divided by an intermediate wall or multiple intermediate walls into the multiple reservoir chambers, wherein the intermediate walls may be configured as bulkheads. This/these intermediate wall(s) extends/extend from a bottom face of the brake fluid reservoir upward to a height which is less than the internal wall height of the brake fluid reservoir, so that a common cohesive region is formed above the reservoir chambers. The fill level may firstly be detected in this common region. If a drop in fill level is detected, the fill level may be detected in only one reservoir chamber, for example the reservoir chamber assigned to the additional pressure source. Thus the performance of reaction measures, including starting of a diagnosis program during driving, becomes at least partially possible.

According to one exemplary arrangement, the measurement assembly has a sensor and a magnet, wherein the measurement assembly is arranged on the brake fluid reservoir such that a position of the magnet changes with the fill level to be detected, wherein the sensor is configured as a Hall sensor, wherein the magnet is received in a float, wherein the fill level in the brake fluid reservoir is detected in analog fashion by determination of a magnetic field generated by the magnet by the sensor. The magnet may be a bipolar magnet or a multipolar magnet. The sensor may be configured as one or more Hall sensors, e.g. one or more linear Hall sensors or 3D Hall sensors, which are arranged in a direction perpendicular to a fluid level of the brake fluid reservoir. The magnet may be configured as or received in a float. Alternatively, one or more magnets may be arranged in a direction perpendicular to a fluid level of the brake fluid reservoir, and the Hall sensor, e.g. a linear Hall sensor or 3D Hall sensor, may be configured as a float. The combination of a Hall sensor and the magnet is distinguished by high reliability and the provision of precise measurement results. In one exemplary arrangement, the float is arranged in a reservoir chamber of the brake fluid reservoir and has horizontal dimensions which are slightly smaller than the horizontal dimensions of the reservoir chamber.

In one exemplary arrangement, the function test described below may be carried out. The float is arranged at a distance from the one or more sensors such that the sensor does not inhibit the function of the float. For example, the sensor is fixedly arranged on the housing inside of the brake fluid reservoir, and the magnet on or in the float. In this way, analog measurement of the fill level of the brake fluid reservoir may take place continuously and hence also the fluid level fall may be determined continuously.

According to one exemplary arrangement, the method furthermore comprises initiation of a reaction measure by a control device of the motor vehicle, and/or starting of a diagnosis program, depending on the behavior of the detected fill level in the brake fluid reservoir, wherein the behavior of the detected fill level constitutes a value, a fall or a fall rate of the detected fill level. Reaction measures which are initiated by the control device are measures which may comprise one or more of provision of information to the driver, storage of information in the diagnostic memory of the motor vehicle, and intervention in the brake system. The information to the driver may comprise information on the severity of a leak, the possibility of eliminating this, information on a time by which a workshop must be or should be visited, and/or a request to park the vehicle immediately. The diagnosis program may have the goal of e.g. locating a leak, possibly categorizing the leak on the basis of its severity, and in some cases initiation of counter-measures to limit or prevent the leak, for example on the basis of a performed categorization. The limitation or prevention may comprise e.g. selective isolation of an individual wheel brake at which the leak has occurred. The value, the fall or fall rate of the detected fill level may serve as indicators of a leak, wherein a degree of fall or a degree of fall rate may indicate the severity of the leak and the measures which may be required.

According to one exemplary arrangement, the initiation of a reaction measure and/or the starting of a diagnosis program takes place depending on the behavior of the detected fill level between a maximally permitted fill level value and a minimally permitted fill level value of the brake fluid reservoir, for example a reservoir chamber of the brake fluid reservoir (for example, only the reservoir chamber assigned to the additional pressure source or plunger assembly). The maximally permitted fill level value may characterize a starting fill level with new brake pads and discs, and the minimally permitted fill level value may characterize a lowest fluid level caused purely by wear on the brake pads and brake discs without fluid loss. At a fill level between the maximally permitted fill level value and minimally permitted fill level value, the fall rate of the fill level may be used to detect a possible leak and/or start a diagnosis program. For example, an increase in fall rate of the detected fill level may point to a possible leak. As another example, the fall rate determined for a lengthy period without leaks, e.g. the mean fall rate for distances of 100 km or 1000 km, within said fill level range (between the maximally permitted fill level value and minimally permitted fill level value) may be used as a reference value. This reference value may be continually compared with a current fall rate, e.g. within the last minute or last five minutes. As soon as the current fall rate significantly exceeds this reference value, i.e. the mean fall rate in a period without leaks, it can be assumed that a leak has occurred and corresponding measures may be taken. Thus a leak may be detected even at a very early stage. Further predetermined fill levels comprise a critical fill level and an empty fill level. At the critical fill level value or below the critical fill level value, an intake of air into the hydraulic unit can no longer be excluded, wherein air is drawn into the hydraulic unit and is thus present therein. At the empty fill level, an analog measurement value of the fill level has reached a bottom stop point. Starting from the minimally permitted fill level value or a lower fill level, a fall or fall rate of the fill level then indicates a fluid loss in the brake system and hence a leak, wherein as a system reaction, a leak test may be performed. These defined fill levels—the maximally permitted fill level value, the minimally permitted fill level value, the critical fill level and the empty fill level—are called markers in the context of the present disclosure. An arbitrary number of further markers or alternative markers may be defined. The use of markers allows better classification of a leak, for example its severity or scope, and the assignment and/or initiation of necessary measures or actions, based on the severity or scope of the leak. Furthermore, graduated system reactions may be made depending on the severity of leak.

According to one exemplary arrangement, the reaction measure comprises the provision of one or more of a brake function degradation, such as a graduated brake function degradation, of the hydraulic brake system; a remaining travel time, for example graduated remaining travel times; a speed limitation, such as graduated maximal speed limitations; and a diagnosis program. The brake function degradation may comprise a reduction in functionality of the brake system, e.g. by selective isolation of a wheel brake from the brake circuit in which a leak has been determined. The degradation may be graduated; here the functionality of the brake system is increasingly reduced in stages, where applicable until a desired effect is obtained, e.g. no leak or a reduced leak. Graduated remaining travel times, a speed limitation and/or graduated maximal speed limitations may provide an arrangement for minimizing a fluid escape and thereby allowing an albeit limited possibility for continued travel.

According to one exemplary arrangement, the diagnosis program comprises one or more of a leak test for locating a leak and also an at least partial containment of the leak in response to a successful location of the leak; a function test of measurement assembly; and an increase in frequency of the leak test and/or the function test, preferably wherein the diagnosis program is started after detection of the leak of the hydraulic brake system based on the behavior the detected fill level and/or after establishing that the motor vehicle is in normal driving mode, has been deactivated or switched off. The leak may be located by selective separation or isolation of individual regions of the brake system, e.g. individual wheel brakes. For example, the individual paths within the brake system may be successively deactivated, and the analog measurement used to check whether the deactivation of one or more parts restricts or completely prevents a fluid loss. By detection of further analog measurement values, it can be determined whether the measure taken has led to success, for example, in the form of a constant fill level; a partial success, such as by a slowing in the fall rate of the fill level; or whether the measure has been unsuccessful, for example if the fall rate of the fill level remains unchanged. The function test of the measurement assembly may take place in various ways well-known to the person skilled in the art. For example, a redundancy sensor may be used in the brake fluid reservoir. The frequency of leak tests may be increased in response to a detected leak because of its severity. Alternatively, the increase in frequency of the test may be adapted according to a fill level marker, e.g. the test frequency may be increased if the fill level falls below a specific fill level marker. Thus in addition to early detection of a leak, it is possible to determine its extent or severity and make a suitable or appropriate reaction.

According to one exemplary arrangement, the leak test comprises initiation of a pressure reduction in at least one fluid path of the hydraulic unit, for example, closure of an outlet valve which is connected to a return line between one of the wheel brakes and the brake fluid reservoir; checking of the fill level in the brake fluid reservoir for a predefined time interval after initiation of the pressure reduction, such as a determination of whether the fill level is falling. Thus the wheel brakes of a motor vehicle can be checked individually, in some cases during travel, and hence a possible leak assigned to a specific wheel brake. The leak may then perhaps be isolated and continued travel made possible.

According to one exemplary arrangement, the function test comprises lowering of a float received in the brake fluid reservoir by creation of a flow in the brake fluid, wherein the flow is created by a suction process by the additional pressure source; detection of a position of the lowered float. The function test of the measurement assembly which is suitable for measuring the fill level in analog fashion, e.g. and for example, a Hall sensor and a magnet, can take place using a suction process by the additional pressure source, e.g. a piston pump, such as a dual action piston pump or duplex pump (DAP, dual acting plunger). The float may be lowered by a flow between the float and reservoir walls adapted accordingly for guidance of the float, in some cases recurrently by repeated creation of the flow in the brake fluid, wherein the float position is detected in analog fashion by the measurement assembly. The dimensions of the reservoir and float contained therein are matched to one another such that a gap, such as a flow gap, exists between the float and guide walls of the brake fluid reservoir. The float may be lowered below the brake fluid level, for example below the fluid surface in the brake fluid reservoir. The high viscosity (e.g. in comparison with water) of the brake fluid present in the brake fluid reservoir here promotes the possibly repeated suction process with associated float movement. This function test or Vacuum Actuated Float test (VAF) is described for example in U.S. Pat. No. 10,814,855 B1 and/or DE 10 2020 209 140 A1, the content of which is hereby incorporated in full by reference. The advantage of this function test, based on a possibly repeated lowering of the float, is that the function test takes little time and in addition can be carried out in the case of a detected leak, e.g. in order to exclude a malfunction of the measurement assembly. Performance even in the case of a leak is promoted by an additional pressure source configured as a dual action piston pump, which can provide a brake force irrespective of the movement direction of the actuator. Thus the function test may perhaps be carried out even during travel. Also, conventional pressure sensors for leak detection cannot easily be subjected to a function test.

According to an exemplary arrangement, the measurement assembly has a sensor and a magnet, wherein the sensor is configured to determine a magnetic field generated by the magnet, wherein the measurement assembly is arranged on the brake fluid reservoir such that a position of the magnet changes with the fill level to be detected, wherein the sensor is configured as a Hall sensor, wherein the magnet is received in a float.

According to an exemplary arrangement, the Hall sensor has a sensor bar which is attached to a side wall of the brake fluid reservoir, and/or the float is arranged between the side wall and an intermediate wall arranged between the reservoir chambers, or between two intermediate walls, such that a gap is formed between the float on one side and the side wall and/or intermediate wall or intermediate walls on the other side.

The control device may be any device which is suitable for performing the present method. The control device provides further, corresponding driving and brake assistance functions. These driving and brake assistance functions are used amongst others for autonomous or partially autonomous driving and also on heavy braking processes. The control device may be implemented in a driving assistance system of the motor vehicle.

Exemplary motor vehicles are cars, trucks, buses or motorcycles. In one exemplary arrangement, the vehicle is a car.

The brake system is an integrated brake system. An integrated brake system is a component which combines a plurality of functions in a compact construction. It is clear that further brake systems may be integrated in the motor vehicle, for example and preferably the hydraulic brake system may have a second e.g. auxiliary or redundant brake system. The second brake system is designed as a partial system, but may however also be complete. In the case of partial design, one or more components of the brake system, e.g. the additional pressure source, the motor, pressure sensors etc., may be present with redundancy.

### BRIEF DESCRIPTION OF DRAWINGS

The disclosure is explained in more detail as an example below with reference to multiple figures. In the drawings,

FIG. 1 shows a schematic illustration of an exemplary hydraulic brake system according to one exemplary arrangement;

FIG. 2 shows a schematic illustration of a brake fluid reservoir of a hydraulic brake system according to a further exemplary arrangement having a first fill level for the brake fluid reservoir;

FIG. 3 shows a schematic illustration of the brake fluid reservoir of FIG. 2, having a second fill level for the brake fluid reservoir;

FIG. 4 shows a schematic illustration of the brake fluid reservoir of FIG. 2, having a third fill level for the brake fluid reservoir;

FIG. 5 shows a schematic illustration of the brake fluid reservoir of FIG. 2, having a fourth fill level for the brake fluid reservoir;

FIG. 6 shows a schematic illustration of an exemplary method for operating the hydraulic brake system, and

FIG. 7 shows a first schematic depiction of the hydraulic brake system to illustrate the method for operating the hydraulic brake system;

FIG. 8 shows a second schematic depiction of the hydraulic brake system to illustrate the method for operating the hydraulic brake system;

FIG. 9 shows a third schematic depiction of the hydraulic brake system to illustrate the method for operating the hydraulic brake system; and

FIG. 10 show a fourth schematic depiction of the hydraulic brake system to illustrate the method for operating the hydraulic brake system.

The same objects, functional units and comparable components carry the same reference signs across all figures. These objects, functional units and comparable components are identical with respect to their technical features unless the description explicitly or implicitly indicates otherwise.

### DETAILED DESCRIPTION

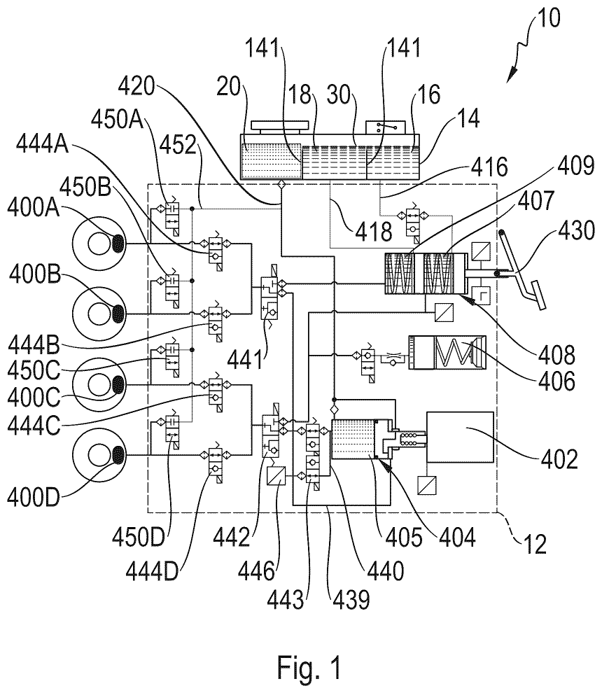

FIG. 1 shows a schematic illustration of a hydraulic brake system 10 for a motor vehicle according to an exemplary arrangement. The hydraulic brake system 10 comprises a hydraulic unit 12, a brake fluid reservoir 14 and multiple (in one exemplary arrangement, four) hydraulically actuatable wheel brakes 400A-D.

The hydraulic unit 12 has a main pressure source 408 which can be actuated by a brake pedal 430, an additional pressure source 404 fluidically separate from the main pressure source 408, and multiple control valves 442 and fluid lines 416, 418, 420, 440, 452. The brake fluid reservoir 14, the main pressure source 408 or the additional pressure source 404, and the wheel brakes 400A-D are connected together via the fluid lines 416, 418, 420, 440, 452 and control valves 442.

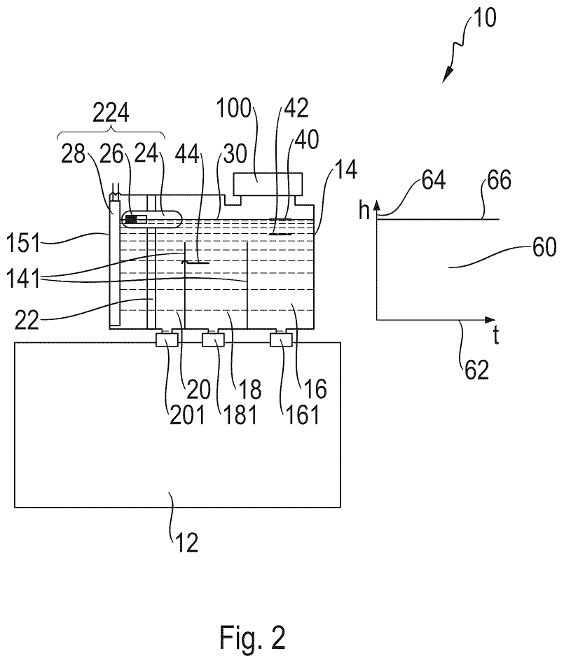

The main pressure source 408, which is here configured as a brake master cylinder, has a primary pressure chamber 407 with a primary piston and a secondary pressure chamber 409 with a secondary piston. The main pressure source 408 is connected to the brake fluid reservoir 14 via infeed lines 416, 418. Each pressure chamber 407, 409 has a dedicated infeed line 416, 418 and a dedicated port 161, 181 (see FIG. 2) on the brake fluid reservoir 14.

The additional pressure source 404, which is here configured as a piston pump, further preferably a dual action piston pump or plunger (DAP, dual acting plunger), has a piston chamber 405 with an additional piston which is connected via a further infeed line 420 to the brake fluid reservoir 14 or a port 201 provided for this (see FIG. 2). The additional pressure source 404 is operated electro-mechanically by a motor 402, for example an electric motor, by which a piston can be moved in the piston chamber 405 of the additional pressure source 404 in order to build up pressure.

Multiple reservoir chambers 16, 18, 20, which are at least partially separated from one another by intermediate walls 141, are provided in the brake fluid reservoir 14 for supplying a brake fluid to the main pressure source 408 or the additional pressure source 404. A first reservoir chamber 16 on which a first port 161 is provided is connected via a first infeed line 416 to the primary pressure chamber 407 in order to supply this with brake fluid. A second reservoir chamber 18 on which a second port 181 is provided is connected via a second infeed line 418 to the secondary pressure chamber 409 in order to supply this with brake fluid. A third reservoir chamber 20 on which the (third) port 201 is provided is connected via the further (third) infeed line 420 to the piston chamber 405 in order to supply this with brake fluid.

The primary pressure chamber 407 of the main pressure source 408 is connected separably via a first control valve 442 to a first brake circuit of the hydraulic unit 12 on which the wheel brakes 400C, 400D are connected. The two wheel brakes 400C, 400D are each connected via an inlet valve 444C, 444D to the first control valve 442 and via an outlet valve 450C, 450D to a return line 452 and hence to the brake fluid reservoir 14. The secondary pressure chamber 409 of the main pressure source 408 is connected separably via a second control valve 441 to a second brake circuit of the hydraulic unit 12 on which the wheel brakes 400A, 400B are connected. The two wheel brakes 400A, 400B are each connected via an inlet valve 444A, 444B to the second control valve 441 and via an outlet valve 450A, 450B to a return line 452 and hence to the brake fluid reservoir 14.

The piston chamber 405 of the additional pressure source 404 is connected separably via a first additional brake line 440 to the first control valve 442 and hence to the first brake circuit of the hydraulic unit 12. Also, the piston chamber 405 of the additional pressure source 404 is connected separably via a second additional brake line 439 to the second control valve 441 and hence to the second brake circuit of the hydraulic unit 12. As FIG. 1 shows purely as an example, an intermediate valve 443 is also connected between the additional pressure source 404 and the first control valve 442, wherein a pressure sensor 446 is provided for determining the fluid pressure prevailing in the piston chamber 405 and at the valves 442, 443.

The first control valve 442 and the second control valve 441 each have separate inputs for the main pressure source 408 and the additional pressure source 404. The hydraulic brake system 10 may for example be operated in a first operating mode in which the additional pressure source 404 is fluidically coupled to the wheel brakes 400A-D, while the main pressure source 408 is fluidically decoupled from the wheel brakes 400A-D. For this, the control valves 441, 442 and the intermediate valve 443 are opened, wherein of the inputs at the control valves 441, 442, only those assigned to the additional pressure source 404 provide a fluidic connection. In the first operating mode, the brake force signal received by the brake pedal 430 is converted by a brake force simulator into a corresponding control signal for the electric motor 402, so that the electric motor 402 causes a displacement of the additional piston in the piston chamber 405 of the additional pressure source 404, leading to a pressure buildup. The hydraulic brake system 10 may also be operated in a second operating mode in which the main pressure source 408 is hydraulically coupled to the wheel brakes 400A-D, while the additional pressure source 404 is fluidically decoupled from the wheel brakes 400A-D. For this, the control valves 441, 442 are opened, wherein of the inputs at the control valves 441, 442, only those assigned to the main pressure source 408 provide a fluidic connection. In the second operating mode, the brake force signal received by the brake pedal 430 can directly cause a displacement of the primary piston and secondary piston in the main pressure source 408, and hence create a pressure buildup.

A further operating mode is however also conceivable, in which both the main pressure source 408 and the additional pressure source 404 are in fluidic connection with the wheel brakes 400A-D. In each of the different operating modes, it is also possible, by targeted opening and closure of the individual inlet valves 444A-D, to bring only some of the wheel brakes 400A-D into fluidic connection with the main pressure source 408 or the additional pressure source 404.

The wheel brakes 400A, B are for example arranged on different sides of the vehicle, for example, diagonally. For example, the wheel brake 400A may be the front right wheel brake (FR) and the wheel brake 400B may be the rear left wheel brake (RL). Accordingly, the wheel brakes 400C, D are, for example arranged on different sides of the vehicle, diagonally. For example, the wheel brake 400C may be the rear right wheel brake (RR) and the wheel brake 400D may be the front left wheel brake (FL). Other arrangements of wheel brakes 400A-D are also conceivable.

FIG. 2 shows a schematic, greatly simplified illustration of a hydraulic brake system 10 according to a further exemplary arrangement. In FIG. 2, the brake fluid reservoir 14 is shown in more detail with the three reservoir chambers 16, 18, 20 separated from one another by the intermediate walls 141. The reservoir chambers 16, 18, 20 each have a port 161, 181, 201 to which the infeed lines 416, 418, 420 are connected for connection to the hydraulic unit 12. The reservoir chambers 16, 18, 20 are connected together above the intermediate walls 141. Alternatively, completely mutually separate reservoir chambers 16, 18, 20 may be present. The hydraulic unit 12 is shown greatly simplified in FIG. 2 and may be configured according to the exemplary arrangement shown in FIG. 1.

As evident for example from FIG. 2, the brake fluid reservoir 14 has a measurement assembly 224 which is arranged in the reservoir chamber 20 assigned to the additional pressure source 404. The measurement assembly 224 is configured to detect, in analog fashion or continuously, a fill level 30 of the brake fluid in the brake fluid reservoir 14. The measurement assembly 224 has a float 24 with a bipolar magnet 26 and a Hall sensor 28. The float 24 is here arranged so as to be movable along a guide 22 running vertically in the middle of the container chamber 20. Here, the float 24 is arranged between a side wall 151 of the brake fluid reservoir 14 and the intermediate wall 141 closer to the side wall 151 (on the left), such that a gap can be maintained between the float 24 and the side wall 151. The Hall sensor 28 with a sensor bar is arranged on or attached to the side wall 151 which, together with the left intermediate wall 141, forms the reservoir chamber 20. The Hall sensor 28 is configured for sensing the magnetic field generated by the magnet 26. The magnet 26 is arranged on a side of the float 24 facing the Hall sensor 28, so that the distance of the magnet 26 from the sensor bar is reduced. This has the advantage that the magnetic field sensing is more precise. Depending on the vertical position of the float 24 and hence also of the magnet 26, the magnetic field intensity is registered by the Hall sensor 26 in a corresponding sensing position along the sensor bar, wherein this sensing position characterizes the current fill level of the brake fluid. For this, the sensor bar may comprise a series of Hall sensor elements which each have an assigned sensing position or sensing range with multiple sensing positions. In this way, analog and hence continuous measurement values can be produced because of the electromagnetic interaction between the Hall sensor 28 and the magnet 26 arranged in the float 24, and sent to a control device 100 of the motor vehicle.

Other exemplary arrangements of the measurement assembly 224 are also conceivable. For example, the Hall sensor 28 or the sensor bar may be formed by or integrated in the guide 22, which is favorable with respect to installation space. Also, multiple sensor bars may be used in combination, e.g. a first sensor bar on the side wall 151 (as shown in FIG. 2), and a second sensor bar on the left intermediate wall 141. Alternatively, the Hall sensor 28 may be arranged in the float 24 and a bar magnet instead arranged on the side wall 151, on the left intermediate wall 141 or in the vertical guide 22. In this case, a magnetic field distribution of the magnet along the travel distance of the float 24 may be predefined. For each given vertical position of the float 24, the magnetic field sensed by the Hall sensor 28 may be compared with the predefined magnetic field distribution, in order then to determine the vertical position on the bar magnet corresponding to the sensed magnetic field and hence the fill level 30 of the brake fluid.

Furthermore, a diagram 60 is shown on the right-hand side of FIG. 2. An abscissa 62 of the diagram 60 designates the time, and the ordinate 64 the height of the fill level 30 (or fluid level) which is continuously provided by the electromagnetic interaction between the magnet 26 and the Hall sensor 28. In the present case, the diagram 60 shows a constant fill level 66 at a maximally permitted fill level 40 of the brake fluid reservoir 14.

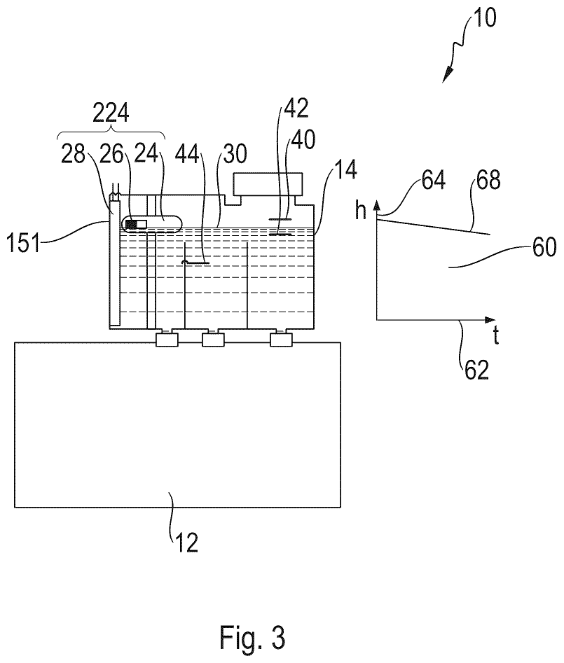

FIGS. 3 to 5 each show schematically the same structure of the hydraulic brake system 10 from FIG. 2, wherein the fill level 30 of the brake fluid contained in the brake fluid reservoir 14 differs from the case shown in FIG. 2. Here, substantially only additional features carry reference signs.

As evident from FIG. 3 which shows the brake fluid reservoir 14 of a hydraulic brake system 10, in the case shown the fill level 30—in comparison with the case shown in FIG. 2, in which the fill level 30 is at a maximally permitted fill level value 40—has fallen to a value between the maximally permitted fill level value 40 and a minimally permitted fill level value 42. Accordingly, the diagram 60 shown on the right in FIG. 3 shows a reducing fill level 68 in the brake fluid reservoir 14, which is continuously detected on the basis of the electromagnetic interaction of the magnet 26 arranged in the float 24 and the Hall sensor 28 of the measurement assembly 224.

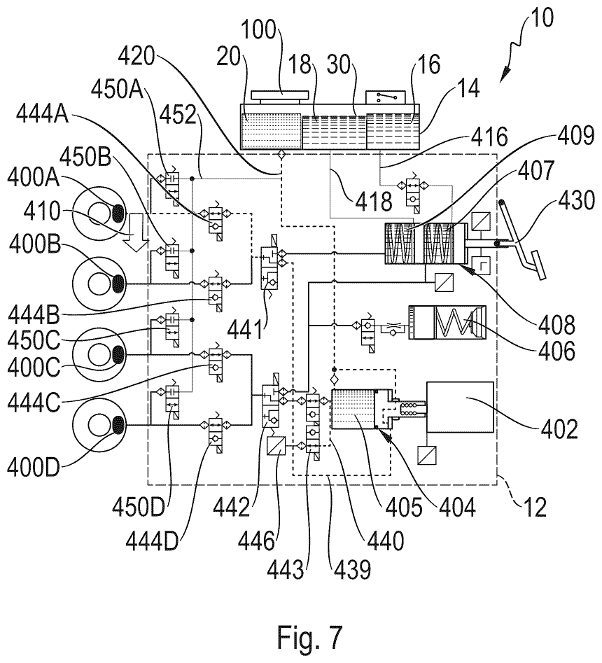

The fill level 30 of the brake fluid reservoir 14, starting from the depicted maximally permitted fill level value 40, may assume a lower fill level over the course of time depending on a condition of the brake pads and brake discs (not shown) firstly and a possible leak 410 (see FIG. 7) of the hydraulic unit 12 secondly. Thus a starting fill level with new brake pads and new brake discs is characterized by the maximally permitted fill level value 40. The lowest fluid level which can be caused purely by wear on the brake pads and brake discs is characterized by the minimally permitted fill level value 42.

Thus the fill level 30 shown in FIG. 3, between the maximally permitted fill level value 40 and the minimally permitted fill level value 42, may be caused purely by normal wear of the brake pads and brake discs of the wheel brakes 400A-D or by a leak 410 in the hydraulic brake system 10.

For the case that a comparison of the fall rate, shown in FIG. 3, of the diminishing fill level 68 with a mean fall rate of the last 100 kilometers travelled by the vehicle shows that the fall rate of the diminishing fill level 68 is greater than the mean fall rate, the presence of a leak 410 in the hydraulic brake system 10 is at least indicated.

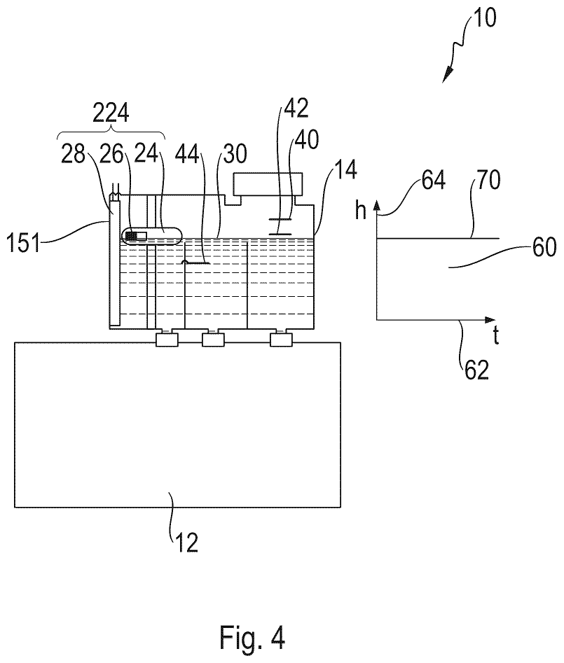

It is clear from FIG. 4 that, despite a brake fluid reservoir 14 initially filled to the maximally permitted fill level value 40, and brake pads and discs in new condition, the fill level 30 continuously measured by the Hall sensor 28 lies below the minimally permitted fill level value 42. This indicates a leak 410, wherein in the case of a conventional motor vehicle without analog detection of the fill level, this would normally be indicated to the driver only by a warning light.

It is however clear from the diagram 60 on the right in FIG. 4 that, despite a fill level 30 below the minimally permitted fill level value 42, a constant fill level 70 is observed. This indicates a stable behavior of the fill level 30, so no further measures are required.

Accordingly, as a reaction measure, further observation may be made by the control device 100 of the motor vehicle. The driver may be warned and a service request issued. A limited remaining travel time may be indicated to the driver, wherein the remaining travel time is determined taking into account the fall rate of the fill level 30. A reaction adapted to the severity of the fault is thus possible.

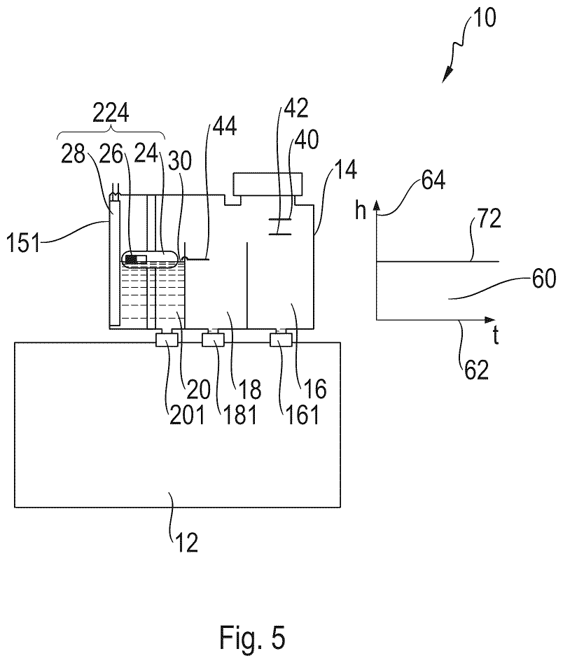

It is clear from FIG. 5 that the fill level 30 in the third reservoir chamber 20 has reached a critical fill level value 44. The fill level 30 of the first and second reservoir chambers 40, 42 is close to an empty fill level. From the diagram 60 on the right in FIG. 5, it can furthermore be gathered that a constant fill level 72 is present in the third reservoir chamber 20. Since the intermediate walls 141 only partially separate the reservoir chambers 16, 18, 20 from one another, at a low fill level 30 corresponding to the critical fill level value 44, the fill level 30 can only be detected in the reservoir chamber 20.

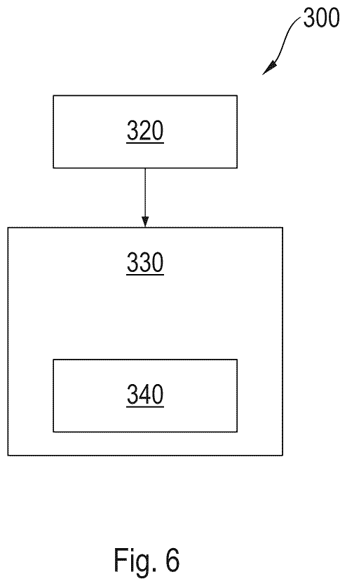

Accordingly, as a first reaction measure, further observation by the control device 100 may be made. As an optional reaction measure, the control device 100 may initiate a diagnosis program 340, for example, a leak test (see FIG. 6) in order to locate the leak 410 and perhaps seal this. A driver warning may be given, and furthermore comprise illumination of the red warning light for the brakes. As a further optional reaction measure, the remaining travel time may be limited and in some cases is dependent on a Functional Safety Analysis (FUSI) according to ISO 26262 and availability requirements.

Furthermore, a boost function implemented via the third reservoir chamber 20 may be disabled and no individual wheel volume control permitted. When the boost function is disabled, the brake force is generated purely by the main pressure source 404.

FIG. 6 shows purely schematically an exemplary method 300 for operating the hydraulic brake system 10.

The method 300 (see FIG. 6) comprises analog or continuous detection 320 of the fill level 30 of the brake fluid present in the brake fluid reservoir 14 by the above-described measurement assembly 224.

The method 300 may furthermore comprise initiation 330 of a reaction measure by a control device 100 (see FIG. 2) depending on the behavior of the detected fill level 30, e.g. a fall or fall rate, in the brake fluid reservoir 14. The reaction measure comprises provision of one or more of a brake function degradation, for example, a graduated brake function degradation, of the hydraulic brake system 10; a remaining travel time, such as graduated remaining travel times; a speed limitation, for example graduated maximal speed limitations; and a diagnosis program.

The method 300 from FIG. 6 is explained in more detail below with reference to FIGS. 7 to 10. Each show schematically and purely as an example the hydraulic brake system 10 according to the exemplary arrangement shown in FIG. 1, wherein a leak 410 of the hydraulic unit 12 is indicated with an arrow. For example, the diagnosis program is described in more detail here using the example of leak containment and a leak test 340. FIGS. 7 to 10 show the brake fluid reservoir 14 in simplified form, wherein this may assume the exemplary arrangement shown with reference to FIGS. 2 to 5. The fluid paths from the third reservoir chamber 20 via the additional pressure source 404 up to the inlet valves 444A-D and/or the wheel brakes 400A-D are shown in dotted lines.

FIG. 7 shows schematically the case in which a leak 410 is detected in the hydraulic brake system 10, for example in the hydraulic unit 12. The leak 410 is detected by the above-mentioned comparison of the fall rates of the fluid level. From the time of occurrence of the leak, the brake fluid begins to flow out of the third reservoir chamber 20.

As an exemplary reaction measure or exemplary diagnosis program, the leak test 340 may be initiated. It can be gathered from FIG. 7 that in the leak test 340, in a first step, the outlet valve 450A of an individual wheel brake 400A is closed. At the same time, the inlet valves 444B-D of the other three wheel brakes 400B-D are closed, so that a pressure builds up in the line to the wheel brake 400A.

From the fill level measurement result detected by the measurement assembly 224, the control device 100 now evaluates whether, in a predefined time interval, the fluid level 30 has fallen. If this is not the case, the outlet valve 450A and the inlet valves 444B-D are opened, and the wheel brake 400B is checked accordingly by closing the outlet valve 450B and the inlet valves 444A, C, D. This can be carried out correspondingly for all wheel brakes 400A-D.

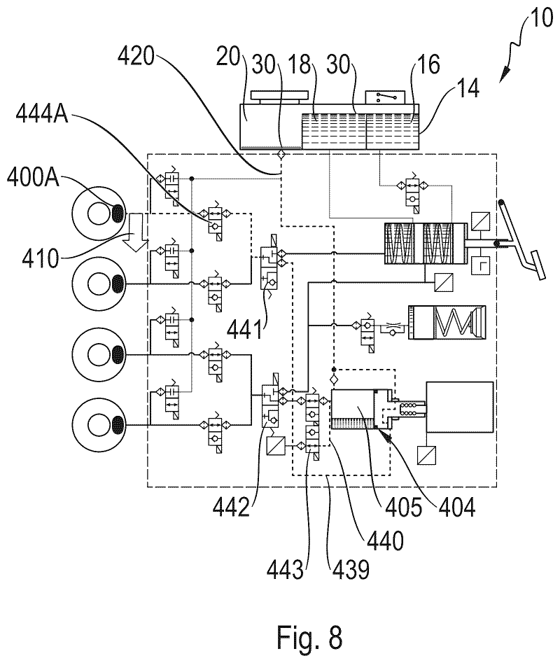

If a leak 410 is located in one of the wheel brakes (in the case of FIG. 7, wheel brake 400A), the control device 100 can calculate or estimate a remaining operating time from the fall rate over the predefined time interval. Thus the leak 410 may in some cases be detected at an early stage, whereby the initiation 330 of further reaction measures or diagnosis programs, including a containment of the leak 410, is possible at an early stage and therefore the driving operation may be only slightly restricted. This is advantageous for preventing excessive leaks, in which the third reservoir chamber 20 may even be completely drained. This may lead to an additional evacuation of the piston chamber 405 of the additional pressure source 404, which is connected to the third reservoir chamber 20 and supplied thereby with brake fluid, reducing the braking effect of the hydraulic brake system 10. This undesired state of the hydraulic brake system 10 is indicated schematically in FIG. 8.

The driver of the motor vehicle is informed of the leak 410 and its severity by the control device. In addition, depending on the severity of the leak 410, the driver may be informed of the remaining operating time of the motor vehicle. The driver may thus know the latest time by which the motor vehicle must be presented to a workshop. In addition, the driver may know the period for which the vehicle remains suitable for use without risk to safe driving.

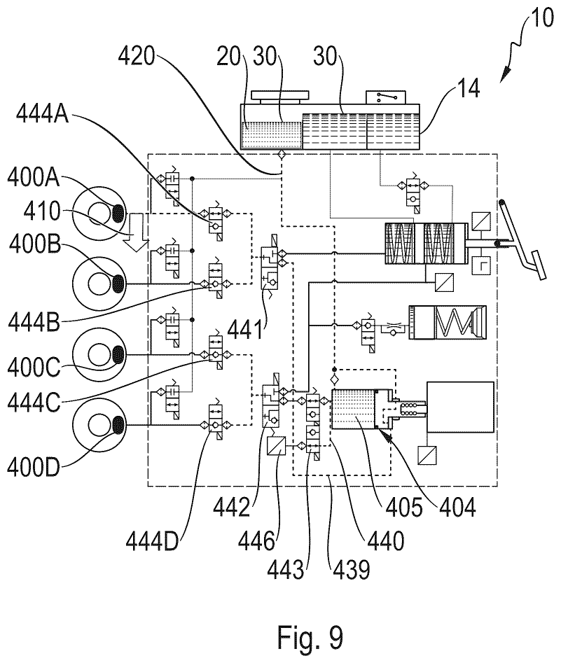

FIG. 9 shows schematically as an example that the fill level 30 of the third reservoir chamber 20 has fallen below the minimally permitted fill level value 42. In the context of the method 300 shown in FIG. 6, analog detection 320 of the fill level 30 takes place by means of the measurement assembly 224 according to the disclosure, which is described above as an example with reference to FIGS. 2 to 5. On the basis of the analog measurement results, the control device 100 arranges an initiation 330 of the leak test 340, during which the leak 410 should be located.

For this, three of the four wheel brakes 400B-D are each selectively isolated from the additional pressure source 404 by the inlet valves 444B-D, such that the respective wheel brakes 400B-D are no longer supplied with brake fluid. For example, first the wheel brake 400A is still supplied with brake fluid with inlet valve 444A open, while the wheel brakes 400B-D are selectively isolated from the additional pressure source 404 by blocking off the inlet valves 444B-D.

Then the additional piston of the additional pressure source 404 is advanced. If a pressure determined at the pressure sensor 446 does not rise proportionally, there is a leak 410 at the wheel brake 400A, which is the case shown in FIG. 9 (i.e. the arrow indicating the leak 410 points to the wheel brake 400A). Internal leaks of the hydraulic brake system 10 can be excluded by regular maintenance and/or self-testing before and/or after travel.

A further reaction measure or further diagnosis program is to increase the frequency with which the fill level 30 is detected by the measurement assembly 224, and/or a further frequency with which the leak test is performed.

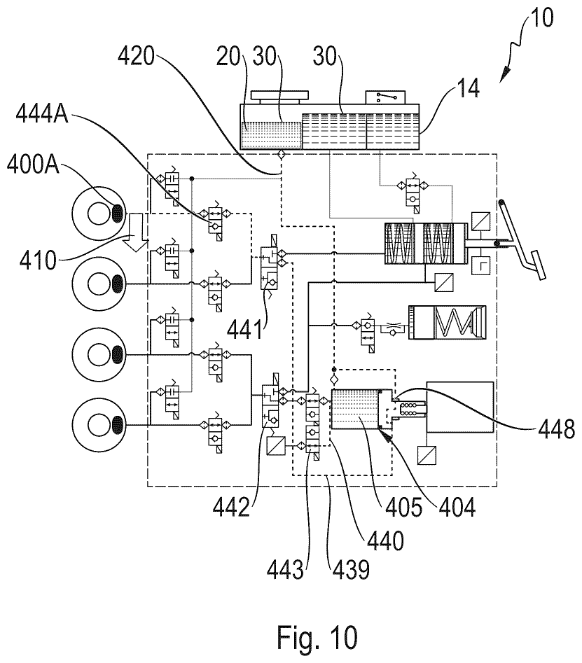

Insofar as the comparison of the fall rates mentioned above with reference to FIG. 3 indicates a major leak 41, as a first reaction measure, an overrun opening 448, shown in FIG. 10 and arranged directly on the additional pressure source 404, may be closed in order to avoid a further loss of brake fluid. At regular time intervals, the overrun opening 448 may be briefly opened to prevent any pressure rise due to heating. Thus a further loss of brake fluid may be contained.

1. A method for operating a hydraulic brake system for a motor vehicle, wherein the hydraulic brake system has a hydraulic unit, a brake fluid reservoir and hydraulically actuatable wheel brakes, wherein the hydraulic unit has a main pressure source which can be actuated via a brake pedal, an additional pressure source fluidically separate from the main pressure source, and control valves by which the main pressure source and the additional pressure source on one side and the wheel brakes on the other side are connected together, wherein in the brake fluid reservoir, multiple at least partially mutually separate reservoir chambers are provided for supplying the main pressure source and the additional pressure source with a brake fluid, wherein the method comprises detection of a fill level of the brake fluid in the brake fluid reservoir by a measurement assembly, wherein the detection of the fill level takes place in analog fashion.

2. The method as claimed in claim 1, wherein the fill level is detected by the measurement assembly in analog fashion firstly in a common region in the brake fluid reservoir above the reservoir chambers separated by one or more intermediate walls, and after detection of a fill level fall in only one of the reservoir chambers, which further is assigned to the additional pressure source.

3. The method as claimed in claim 1, wherein the measurement assembly has a sensor and a magnet, wherein the measurement assembly is arranged on the brake fluid reservoir such that a position of the magnet changes with the fill level to be detected, wherein the sensor is configured as a Hall sensor, wherein the magnet received in a float, wherein the fill level in the brake fluid reservoir is detected in analog fashion by determination of a magnetic field generated by the magnet by the Hall sensor.

4. The method as claimed in claim 1, wherein the method furthermore comprises initiation of a reaction measure by a control device of the motor vehicle depending on a behavior of the detected fill level in the brake fluid reservoir, wherein the behavior of the detected fill level constitutes a value, a fall or a fall rate of the detected fill level.

5. The method as claimed in claim 4, wherein the initiation of a reaction measure takes place depending on behavior of the detected fill level between a maximally permitted fill level value and a minimally permitted fill level value of a reservoir chamber of the brake fluid reservoir.

6. The method as claimed in claim 4, the reaction measure comprising the provision of one or more of:
a brake function degradation of the hydraulic brake system,
a remaining travel time, and
a speed limitation,
a diagnosis program.

7. The method as claimed in claim 6, the diagnosis program comprising one or more of:
a leak test for locating a leak, and also an at least partial containment of the leak in response to a successful location of the leak,
a function test of the measurement assembly, and
an increase in frequency of the leak test and/or the function test,
wherein the diagnosis program is started after detection of the leak of the hydraulic brake system based on the behavior the detected fill level and/or after establishing that the motor vehicle is in normal driving mode, has been deactivated or switched off.

8. The method as claimed in claim 7, the leak test comprising:
initiation of pressure reduction in at least one fluid path of the hydraulic unit, closure of an outlet valve which is connected to a return line between one of the wheel brakes and the brake fluid reservoir,
checking of the fill level in the brake fluid reservoir for a predefined time interval after initiation of the pressure reduction, determination of whether the fill level is falling.

9. The method as claimed in claim 7, the function test comprising:
lowering of a float received in the brake fluid reservoir, below the brake fluid level, by creation of a flow in the brake fluid, wherein the flow is created by a suction process by the additional pressure source,
detection of a position of the lowered float.

10. A hydraulic brake system for a motor vehicle, comprising a hydraulic unit, a brake fluid reservoir and hydraulically actuatable wheel brakes, wherein the hydraulic unit has a main pressure source which can be actuated via a brake pedal, an additional pressure source fluidically separate from the main pressure source, and control valves by which the main pressure source and the additional pressure source on one side and the wheel brakes on the other side are connected together, wherein in the brake fluid reservoir, multiple, at least partially mutually separate reservoir chambers are provided for supplying the main pressure source and the additional pressure source with a brake fluid, furthermore comprising a measurement assembly for analog detection of a fill level of the brake fluid in the brake fluid reservoir.

11. The brake system as claimed in claim 10, wherein the measurement assembly has a sensor and a magnet, wherein the sensor is configured to determine a magnetic field generated by the magnet, wherein the measurement assembly is arranged on the brake fluid reservoir such that a position of the magnet changes with the fill level to be detected, wherein the sensor is configured as a Hall sensor, wherein the magnet is received in a float.

12. The brake system as claimed in claim 11, wherein the Hall sensor has a sensor bar which is attached to a side wall of the brake fluid reservoir, and/or wherein the float is arranged between the side wall and an intermediate wall arranged between the reservoir chambers, or between two intermediate walls, such that a gap is formed between the float on one side and the side wall and/or intermediate wall or intermediate walls on the other side.

13. A control device for operating a hydraulic brake system, wherein the control device is adapted to perform the method as claimed in claim 1.

14. A motor vehicle comprising the control device as claimed in claim 13.

15. The method as claimed in claim 2, wherein the measurement assembly has a sensor and a magnet, wherein the measurement assembly is arranged on the brake fluid reservoir such that a position of the magnet changes with the fill level to be detected, wherein the sensor is preferably configured as a Hall sensor, wherein the magnet is received in a float, wherein the fill level in the brake fluid reservoir is detected in analog fashion by determination of a magnetic field generated by the magnet by the Hall sensor.

16. The method as claimed in claim 15, wherein the method furthermore comprises initiation of a reaction measure by a control device of the motor vehicle depending on a behavior of the detected fill level in the brake fluid reservoir, wherein the behavior of the detected fill level constitutes a value, a fall or a fall rate of the detected fill level.

17. The method as claimed in claim 5, the reaction measure comprising the provision of one or more of:
a brake function degradation of the hydraulic brake system,
graduated remaining travel times, and
graduated maximal speed limitations,
a diagnosis program.

18. The method as claimed in claim 8, the function test comprising:
lowering of a float received in the brake fluid reservoir, below the brake fluid level, by creation of a flow in the brake fluid, wherein the flow is created by a suction process by the additional pressure source,
detection of a position of the lowered float.
